(19) United States
(12) Patent Application Publication
(10) Pub. No.: US 2008/0018117 A1
(43) Pub. Date: Jan. 24, 2008

(54) Cam-lock mechanism for a storm door

(76) Inventor: Noubar Yeremian, Wayne, PA (US)

Correspondence Address: RATNERPRESTIA, P O BOX 980, VALLEY FORGE, PA, 19482-0980, US

(21) Appl. No.: 11/811,537

(22) Filed: Jun. 11, 2007

Related U.S. Application Data
(60) Provisional application No. 60/812,513, filed on Jun. 9, 2006.

(51) Int. Cl. E05C 3/06

(52) U.S. Cl. 292/197; 160/381; 292/257

(57) ABSTRACT

An apparatus for mounting a removable panel insert to a door frame is provided. The apparatus comprises a lock rotatably coupled with respect to the door frame, whereby the lock includes a bearing surface and an engagement portion distal to the bearing surface. The lock is selectively rotatable between a locked position and an unlocked position. In the locked position, the bearing surface of the lock is positioned to bear on a surface of the door frame, and the panel insert is interposed between the door frame and the engagement portion of the lock for urging the panel insert in a direction toward the door frame. In the unlocked position, the bearing surface of the lock is separated from the surface of the door frame, and the engagement portion of the lock is separated from the panel insert for permitting installation or removal of the panel insert from the door frame.

### CROSS REFERENCE TO RELATED APPLICATIONS

This application claims the benefit of the filing date of the provisional application entitled “CAM-LOCK MECHANISM FOR A STORM DOOR” filed Jun. 9, 2006 and assigned Ser. No. 60/812,513, the contents of which are incorporated herein by reference.

### FIELD OF THE INVENTION

This invention relates to a locking fastener system for removable mounting of a panel insert, such as a glass panel or a wire mesh screen, to the frame of a storm door.

### BACKGROUND OF THE INVENTION

Many conventional doors have removable panel inserts, such as a glass panel or a wire mesh screen. Such conventional doors include storm doors, screen doors or aluminum doors, for example. The panel inserts may be removed for replacement, service, cleaning or any other purpose. For example, a glass panel may be replaced with a wire mesh screen in the summer months, and the wire mesh screen may be replaced with the glass panel in the winter months. There is a need to further develop and improve fastener systems for removable mounting of a panel insert to the door in the interests of convenience and safety.

### SUMMARY OF THE INVENTION

According to one aspect of the invention an apparatus for mounting a removable panel insert to a door frame is provided. The apparatus comprises a lock rotatably coupled with respect to the door frame, whereby the lock includes a bearing surface and an engagement portion distal to the bearing surface. The lock is selectively rotatable between a locked position and an unlocked position. In the locked position, the bearing surface of the lock is positioned to bear on a surface of the door frame, and the panel insert is interposed between the door frame and the engagement portion of the lock for urging the panel insert in a direction toward the door frame. In the unlocked position, the bearing surface of the lock is separated from the surface of the door frame, and the engagement portion of the lock is separated from the panel insert for permitting installation or removal of the panel insert from the door frame.

According to another aspect of the invention, the apparatus further comprises a fastener having a surface for engaging a keyed slot defined on the lock, wherein rotation of the fastener induces movement of the engagement portion of the lock with respect to the panel insert.

According to yet another aspect of the invention, a door is provided. The door comprises a door frame, a panel insert releasably mounted to the door frame, and at least one lock rotatably coupled to the door frame. The lock includes a bearing surface, and an engagement portion distal to the bearing surface. The lock is selectively rotatable between the locked position and the unlocked position.

### BRIEF DESCRIPTION OF THE DRAWINGS

Exemplary embodiments of the invention will be described with reference to several embodiments selected for illustration in the drawing, of which:

FIG. 1 is a rear elevation view of a door according to aspects of the invention;

FIG. 2 is a cross-sectional view of the door shown in FIG. 1 taken along the lines 2-2;

FIG. 3 is a detailed view of the door rail and fasteners shown in FIG. 2, rotated 90° counterclockwise;

FIG. 4 is an exploded perspective view of the door rail and fasteners shown in FIG. 3;

FIG. 5 is a rear elevation view of a lock shown in FIG. 4; and

FIG. 6 is a rear elevation view of the door rail and fasteners shown in FIG. 3.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the figures, a door 5 generally includes a door frame 15 and a panel insert 18 mounted to the door frame 15. According to one exemplary embodiment, the door 5 is a glass storm door, although, it should be understood that the door may also be a wire mesh screen door, panel door, or any other style of door. Accordingly, item 18 may represent a glass panel, wire mesh screen, or a solid panel that is mounted in a flange 32.

According to one aspect of the invention an apparatus for mounting a removable panel insert 18 (and optionally 32) to a door frame 15 is provided. The apparatus comprises a lock 24 rotatably coupled with respect to the door frame 15, whereby the lock 24 includes a bearing surface 38 and an engagement portion 46 distal to the bearing surface 38. The lock 24 is selectively rotatable between a locked position and an unlocked position. In the locked position, the bearing surface 38 of the lock is positioned to bear on a surface 39 of the door frame 15, and the panel insert 18 (and optionally 32) is interposed between the door frame 15 and the engagement portion 46 of the lock 24 for urging the panel insert 18 (and optionally 32) in a direction toward the door frame 15. In the unlocked position, the bearing surface 38 of the lock 24 is separated from the surface 39 of the door frame 15, and the engagement portion 46 of the lock 24 is separated from the panel insert 18 (and optionally 32) for permitting installation or removal of the panel insert 18 (and optionally 32) from the door frame 15.

According to another aspect of the invention, the apparatus further comprises a fastener 20 having a surface 42 for engaging a keyed slot 36 defined on the lock 24, wherein rotation of the fastener 20 induces movement of the engagement portion 46 of the lock 24 with respect to the panel insert 18 (and optionally 32).

According to yet another aspect of the invention, a door 5 is provided. The door 5 comprises a door frame 15, a panel insert 18 (and optionally 32) releasably mounted to the door frame 15, and a lock 24 rotatably coupled to the door frame 15. The lock includes a bearing surface 38, and an engagement portion 46 spaced from the bearing surface 38. The lock 24 is selectively rotatable between the locked position and the unlocked position, as described above.

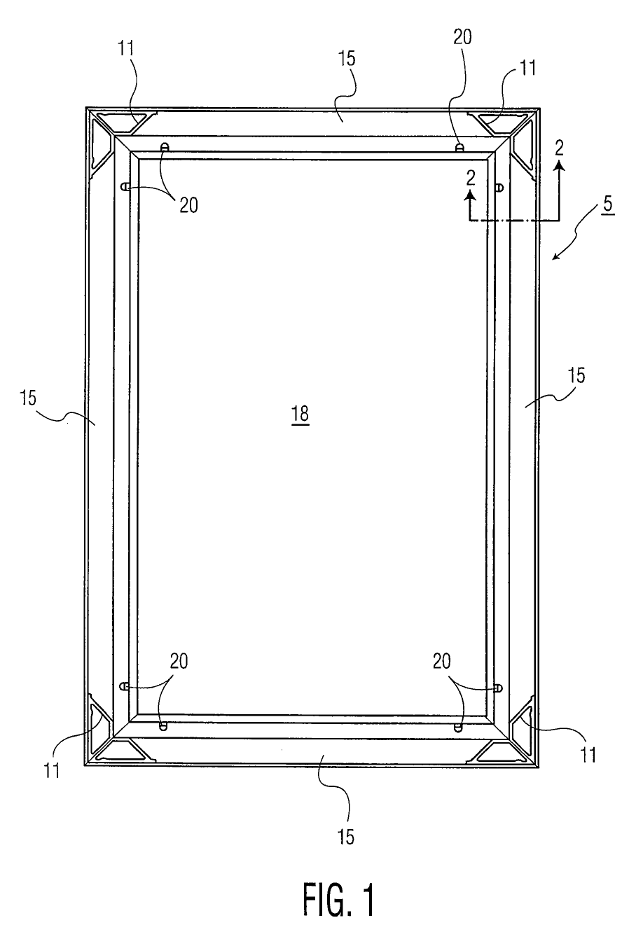

Referring now to FIG. 1, an exemplary embodiment of a door 5 is illustrated. The exemplary door 5 comprises four adjoining door frame members 15. The door frame members 15 are joined together by four gussets 11 that are fixedly mounted to the four interior corners of door 5. The adjoining door frame members 15 together define a rectangular opening, through which panel insert 18 is positioned. The panel insert 18 is mounted to door frame members 15 by a series of fasteners 20 disposed at the opposing ends of each door frame member 15, as explained in greater detail below. The quantity and location of fasteners 20 may vary depending upon the shape and weight of panel insert 18.

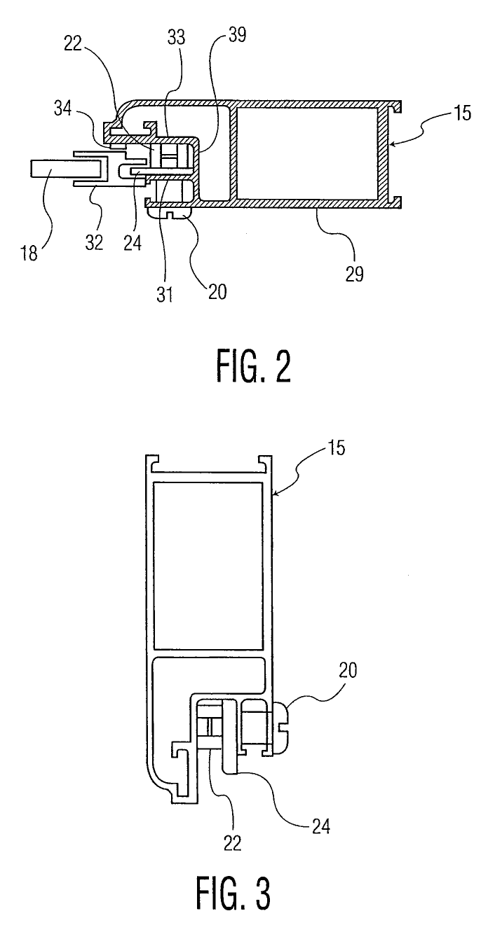

A cross-sectional view of door 5 taken along the lines 2-2 of FIG. 1 is shown in FIG. 2. As shown in FIG. 2, a fastener 20 is fixedly mounted to collar set screw 22. The collar set screw 22 may be a standard threaded nut, for example. The shaft portion of fastener 20 is carried in clearance holes disposed in door frame member 15 and lock 24. The size of the slotted head of the fastener 20 is minimized to achieve a low profile, “slim-line” effect. The lock 24 and collar set screw 22 are juxtaposed between intermediate wall 33 and wall 31 of door frame member 15. The lock 24 maintains mounting flange 32 in a state of compression against a gasket 34. The gasket 34 is mounted to intermediate wall 33 of door frame member 15. The gasket 34 (or weather seal) limits the passage of air and debris through the interface between panel insert 18 and door frame member 15.

The panel insert 18 is mounted within a U-shaped channel of mounting flange 32. The mounting flange 32 is optionally mounted to all four edges of panel insert 18, and each mounting flange 32 optionally extends the entire length of each edge of the panel insert 18. The mounting flange 32 may be adhered to panel insert 18 with adhesive or fixed to panel insert 18 by a fastener (not shown) or any other fastening means known in the art. Alternatively, if mounting flanges 32 are mounted to all four edges of panel insert 18, panel insert 18 may be captivated within the U-shaped channels of the mounting flanges 32 without any fasteners or adhesive.

The term ‘panel insert’ 18 may refer to an assembly including a glass panel (or wire mesh screen) and the mounting flange 32. Alternatively, the term ‘panel insert’ 18 may refer to the glass panel or wire mesh screen alone, as one skilled in the art will recognize that mounting flange 32 is an optional component.

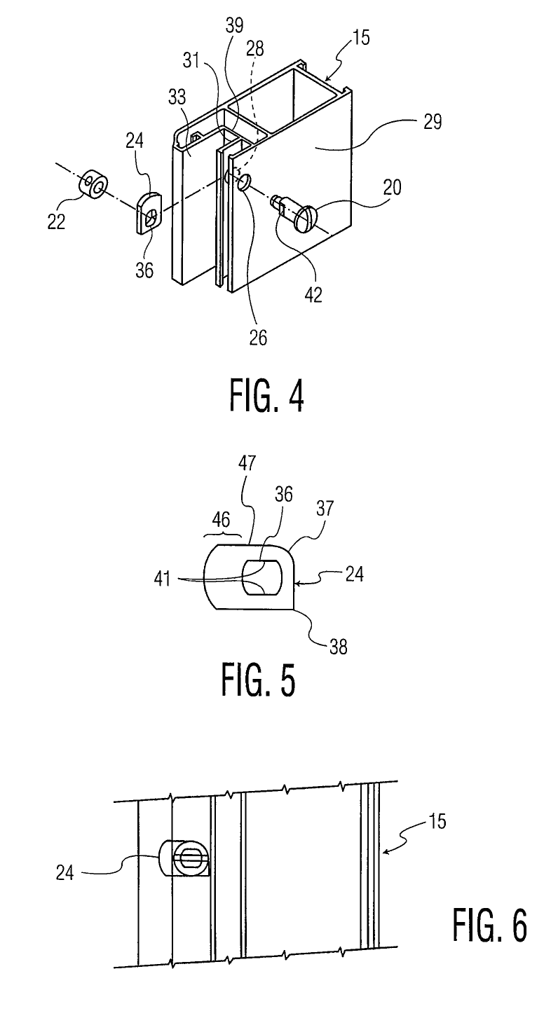

FIGS. 3 and 4 depict a detailed view of the door frame, whereby panel insert 18 and mounting flange 32 are omitted for clarity. The shaft of the fastener 20 is positioned thru clearance hole 26 disposed in interior wall 29 and clearance hole 28 disposed in wall 31 of door frame member 15. The clearance holes 26, 28 are axially aligned. Furthermore, fastener 20 is also positioned thru keyed slot 36 of lock 24 that is positioned between walls 31 and 33. The head of fastener 20 is seated on interior wall 29 of door frame member 15.

The end of fastener 20, that is distal to the fastener head, is fixedly mounted to collar set screw 22, by any manner known in the art. For example, the fastener 20 may be threadedly coupled, fastened, or adhered to collar set screw 22. Collar set screw 22 is configured to rotate with fastener 20. The lock 24 and collar set screw 22 are snugly mounted between intermediate wall 33 and wall 31 of door frame member 15 with minimal clearance, so that lock 24 may retain mounting flange 32 in a state of compression with gasket 34. According to one exemplary embodiment of the invention, the assembly of fastener 20, collar set screw 22, and lock 24 may be referred to as an apparatus, a fastener assembly or a fastener system.

Referring now to FIGS. 3-5, fastener 20 includes opposing planar surfaces 42 (only one planar portion illustrated in FIG. 4) that cooperate with the planar surfaces 41 of keyed slot 36 (see FIG. 4), such that rotation of fastener 20 induces rotation of lock 24. One skilled in the art will recognize that the number and position of planar surfaces 41 and 42 may vary. Additionally, one skilled in the art will recognize that other ways exist to captivate the fastener 20 and the lock 24.

The lock 24 is configured to rotate between locked and unlocked positions. The locked and unlocked positions are separated by 90 degrees. More specifically, the lock 24 is horizontally oriented in the locked position as depicted in FIGS. 2, 3 and 6; and lock 24 is vertically oriented in the unlocked position as depicted in FIG. 4.

In the locked position, the lock 24 urges the mounting flange 32 of the panel insert 18 against the door frame member 15. In the unlocked position, the entire body of lock 24 is positioned between intermediate wall 33 and wall 31 of door frame member 15, such that lock 24 is separated from mounting flange 32 and panel insert 18. The panel insert 18 (along with mounting flange 32) may be removed from door 5 in the unlocked position of lock 24. As described in the background section, the panel insert 18 may be removed from the door 5 and exchanged with a wire mesh screen, or, alternatively, the panel insert 18 may be removed for replacement, service, cleaning or any other purpose.

Referring still to FIGS. 3-5, the rotational range of the lock 24 is approximately about ninety (90) degrees. Counterclockwise rotation of lock 24 is limited by engagement between bearing surface 38 of lock 24 and wall 39 of door frame member 15 to limit counterclockwise rotation of lock 24 beyond the locked position shown in FIGS. 2, 3 and 6. The bearing surface 38 may be a corner, as shown, or may be any other surface or feature for bearing against the wall 39 of door frame member 15 to limit counterclockwise rotation of lock 24.

Clockwise rotation of lock 24 is limited by engagement between surface 47 of the lock 24 and wall 39 of door frame member 15. The rounded edge 37 of lock 24 provides clearance between the body of lock 24 and wall 39, such that lock 24 may pivot in the clockwise direction toward the unlocked position.

No special tools are required for removing or installing a panel insert 18 from the door frame. The fastener 20 optionally includes a slotted head, such that the fastener 20 may be rotated by a flat-head screwdriver or a penny.

According to an exemplary embodiment of the invention, fastener 20, collar set screw 22, lock 24, and mounting flange 32 are all optionally composed of steel for its superior wear resistance and material properties.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. An apparatus for mounting a removable panel insert to a door frame comprising:
a lock rotatably coupled with respect to the door frame, said lock including a bearing surface and an engagement portion distal to the bearing surface;
the lock being selectively rotatable between a locked position and an unlocked position, wherein in the locked position the bearing surface of the lock is positioned to bear on a surface of the door frame, and the panel insert is interposed between the door frame and the engagement portion of the lock for urging the panel insert in a direction toward the door frame, and in the unlocked position the bearing surface of the lock is separated from the surface of the door frame, and the engagement portion of the lock is separated from the panel insert for permitting installation or removal of the panel insert from the door frame.

2. The apparatus of claim 1, wherein the lock is configured to rotate along an angle of approximately about ninety degrees.

3. The apparatus of claim 1, wherein the rotational range of the lock is approximately about ninety degrees.

4. The apparatus of claim 1, wherein the lock further comprises a rounded surface opposite the bearing surface that is sized to clear the surface of the door frame upon rotation of the lock.

5. The apparatus of claim 1 further comprising a fastener coupled to the lock, wherein rotation of the fastener induces movement of the engagement portion of the lock with respect to the panel insert.

6. The apparatus of claim 5 further comprising a set screw coupled to the fastener for retaining the fastener to the door frame.

7. The apparatus of claim 5, wherein rotation of the fastener induces movement of the engagement portion of the lock with respect to the panel insert.

8. The apparatus of claim 1, wherein the bearing surface of the lock is defined by a corner edge disposed along the perimeter of the lock.

9. An apparatus for mounting a removable panel insert to a door frame comprising:
a moveable lock having a keyed slot and an engagement portion distal to the keyed slot; and
a fastener having a surface for engaging the keyed slot of the lock, wherein rotation of the fastener induces movement of the engagement portion of the lock with respect to the panel insert,
the lock being selectively moveable between an unlocked position where the engagement portion of the lock is separated from the panel insert for permitting installation or removal of the panel insert from the door frame, and a locked position where the panel insert is interposed between the engagement portion of the lock and the door frame for urging the panel insert in a direction toward the door frame.

10. The apparatus of claim 9 wherein the surface of the fastener is planar for bearing on a planar surface of the keyed slot disposed within the lock.

11. The apparatus of claim 9, wherein the lock is selectively rotatable between the unlocked position and the locked position.

12. The apparatus of claim 11, wherein the rotational range of the lock is approximately about ninety degrees.

13. The apparatus of claim 9 further comprising a set screw coupled to the fastener for retaining the fastener to the door frame.

14. A door comprising:
a door frame;
a panel insert releasably mounted to the door frame; and
at least one lock rotatably coupled with respect to the door frame, said lock including a bearing surface, and an engagement portion distal to the bearing surface;
the lock being selectively rotatable between a locked position and an unlocked position, wherein in the locked position the bearing surface of the lock is positioned to bear on a surface of the door frame, and the panel insert is interposed between the door frame and the engagement portion of the lock for urging the panel insert in a direction toward the door frame, and in the unlocked position the bearing surface of the lock is separated from the surface of the door frame, and the engagement portion of the lock is separated from the panel insert for permitting installation or removal of the panel insert from the door frame.

15. The door of claim 14, wherein the panel insert comprises a glass panel or a mesh screen.

16. The door of claim 15, wherein the panel insert comprises a flange mounted to at least a portion of the perimeter of the glass panel or mesh screen, and the lock is positioned for selective engagement with the flange.

17. The door of claim 14, wherein at least a portion of the lock is positioned within a channel of the door frame.

18. The door of claim 14, wherein the bearing surface of the lock is defined by a corner edge disposed along the perimeter of the lock.

19. The door of claim 14 further comprising a fastener coupled to the lock, wherein rotation of the fastener induces movement of the engagement portion of the lock with respect to the panel insert.

20. The door of claim 14 further comprising a set screw coupled to the fastener for retaining the fastener to the door frame.
